(19) United States
(12) Patent Application Publication
(10) Pub. No.: US 2020/0310561 A1
(43) Pub. Date: Oct. 1, 2020

(54) INPUT DEVICE FOR USE IN 2D AND 3D ENVIRONMENTS

(71) Applicant: Logitech Europe S.A., Lausanne (CH)

(72) Inventors: Andreas Connellan, Dublin (IE); Aidan Kehoe, Co. Cork (IE); Oliver Riviere, Co. Cork (IE); James McIntyre, Co. Cork (IE)

(21) Appl. No.: 16/370,648

(22) Filed: Mar. 29, 2019

(51) Int. Cl. G06F 3/0354; G06F 3/0346; G06F 3/038; G06F 3/0481; G06T 19/00

(52) U.S. Cl. CPC G06F 3/03545; G06F 3/0346; G06T 19/003; G06F 3/04815; G06F 3/0383

(57) ABSTRACT

An input device (e.g., a stylus) can be configured for use in an augmented/virtual reality environment and can include a housing and a first and second sensor set configured on a surface of the housing. The first and second sensor sets can be controlled by one or more processors that are configured to generate a first function in response to the first sensor set detecting a pressing force on a first region of the housing, and generate a second function in response to the second sensor set detecting a squeezing force on a second region of the housing. A first parameter of the first function may be modulated based on a magnitude of the first pressing force on the first region, and a parameter of the second function may be modulated based on a magnitude of the squeezing force on the second region.

### CROSS-REFERENCES TO RELATED APPLICATIONS

This application is related to U.S. application Ser. No. 16/054,944, filed on Aug. 3, 2018, and titled “Input Device for Use in an Augmented/Virtual Reality Environment,” which is hereby incorporated by reference in its entirety for all purposes.

### BACKGROUND

Virtual, mixed, or augmented reality can be associated with a variety of applications that comprise immersive, highly visual, computer-simulated environments. These environments, commonly referred to as augmented-reality (AR)/virtual-reality (VR) environments, can simulate a physical presence of a user in a real or imagined world. The computer simulation of these environments can include computer rendered images, which can be presented by means of a graphical display. The display can be arranged as a head mounted display (HMD) that may encompass all or part of a user's field of view.

A user can interface with the computer-simulated environment by means of a user interface device or peripheral device. A common controller type in many contemporary AR/VR systems is the pistol grip controller, which can typically operate with three or six degrees-of-freedom (DOF) of tracked movement, depending on the particular system. When immersed in a computer-simulated AR/VR environment, the user may perform complex operations associated with the interface device, including simulated movement, object interaction and manipulation, and more. Despite their usefulness, pistol grip controllers in contemporary AR/VR systems tend to be bulky, unwieldy, cumbersome, and can induce fatigue in a user due to its weight and large tracking features that often include an obtrusive and protruding donut-shaped structure. The pistol grip shape can help minimize fatigue as a user can typically hold objects in a pistol grip configuration for longer periods of time, but at the cost of only allowing coarse and inarticulate movement and ungainly control. Thus, there is need for improvement in interface devices when operating within virtualized environments, especially when performing tasks that require a high degree of precision and fine control.

### BRIEF SUMMARY

In certain embodiments, an input device (e.g., stylus device) can comprise a housing, a first sensor set (e.g., one or more load cells) configured on a surface of the housing, and a second sensor set (e.g., one or more load cells) configured on the surface of the housing. The first and second sensor sets can be controlled by and in electronic communication with one or more processors, where the one or more processors are configured to generate a first function (e.g., a writing/drawing function) in response to the first sensor set detecting a pressing force (e.g., by a user) on a first region of the housing, and where the one or more processors are configured to generate a second function (e.g., a “grab” function in an AR/VR environment) in response to the second sensor set detecting a squeezing force on a second region of the housing. A first parameter of the first function can be modulated based on a magnitude of the first pressing force on the first region, and a parameter of the second function can be modulated based on a magnitude of the squeezing force on the second region. For instance, less force may modulate the first/second functions less as compared to a greater force.

In some embodiments, the input device may further include a third sensor set configured at an end of the housing, the third sensor set controlled by and in electronic communication with the one or more processors, where the one or more processors can be configured to generate the first function in response to the third sensor set detecting a third pressing force that is caused when the end of the housing is pressed against a physical surface. In some aspects, the first sensor set can include a first load cell coupled to a user accessible button configured in the first region on the surface of the housing, where the second region includes a first sub-region and a second sub-region, the first and second sub-regions configured laterally on opposite sides of the housing, where the second sensor set includes at least one load cell on at least one of the first or second sub-regions, and wherein the third sensor set includes a load cell coupled to a nib (e.g., tip 310 of input device 300) on the end of the housing. By way of example, the first and second sub-regions can be on the left/right sides of the housing to detect a squeezing or pinching force, as described below with respect to the “grip buttons.” In some implementations, the housing is configured to be held by a user's hand such that the first sensor set is accessible by the user's index finger, the second sensor set is accessible by the user's thumb and at least one of the user's index or middle finger, and a rear portion of the housing is supported by the user's purlicue region of the user's hand, as shown and described below with respect to FIG. 6.

In further embodiments, a method of operating an input device (e.g., a stylus device) can include: receiving first data corresponding to a tip of the stylus device (e.g., tip 310) being pressed against a physical surface, the first data generated by a first sensor set (e.g., one or more load cells, such as piezo or strain gauge type cells) configured at the tip of the stylus device (sometimes referred to as a “nib”) and controlled by one or more processors (e.g., disposed within the stylus device, in an off-board host computing device, or a combination thereof); generating a function (e.g., a writing/painting/drawing function) in response to receiving the first data; receiving second data corresponding to an input element on the stylus device being pressed by a user, the second data generated by a second sensor set configured on the side of the stylus device and controlled by the one or more processors; and generating the function in response to receiving the second data. In some cases, the first data can include a first detected pressing force corresponding to a magnitude of force detected by the first sensor set, and the second data may include a second detected pressing force corresponding to a magnitude of force detected by the second sensor set. The method can further include modulating a parameter of the function based on either of the first detected pressing force or the second detected pressing force. The method may further comprise receiving third data corresponding to the stylus device being squeezed, the third data generated by a third sensor set coupled to the stylus device and controlled by the one or more processors; and generating a second function in response to receiving the third data. The third data can include a detected magnitude of a squeezing force, and wherein the method further comprises modulating a parameter of the second function based on a detected magnitude of the squeezing force.

According to some embodiments, an input device (e.g., a stylus device) can comprise a housing configured to be held by a user while in use, the housing including: a first sensor set configured at an end of the housing; and a second sensor set configured on a surface of the housing, the first and second sensor sets controlled by and in electronic communication with one or more processors, where the one or more processors are configured to generate a function in response to the first sensor set detecting a first pressing force that is caused when the end of the housing is pressed against a physical surface, where the one or more processors are configured to generate the function in response to the second sensor set detecting a second pressing force that is caused when the user presses the second sensor, and wherein a parameter of the function is modulated based on a magnitude of either the first pressing force or the second pressing force. The first sensor set can include a load cell coupled to a nib on the end of the housing. The second sensor set can include a load cell coupled to a button on the surface of the housing. In some cases, the input device may further comprise a touch-sensitive touchpad configured on the surface of the housing, the touchpad controlled by and in electronic communication with the one or more processors, wherein the touchpad is configured to detect a third pressing force on a surface of the touchpad. The touchpad may include one or more load cells coupled thereto, wherein the one or more processors are configured to determine a resultant force signal based on a magnitude of the third pressing force and a location of the third pressing force relative to the one or more load cells.

The input device may further comprise a third sensor set coupled to one or more sides of the housing and configured to be gripped by a user while the stylus device is in use, wherein the third sensor set is controlled by and in electronic communication with the one or more processors, and wherein the one or more processors are configured to generate a second function in response to the third sensor set detecting a gripping force that is caused when the user grips the third sensor set. The input device can be configured for operation in an augmented reality (AR), virtual reality (VR), or mixed reality (MR) environment. In some cases, the second function can be a digital object grab function performed within the AR/VR/MR environment. The input device may comprise a communications module disposed in the housing and controlled by the one or more processors, the communications module configured to establish a wireless electronic communication channel between the stylus device and at least one host computing device. In some aspects, the function(s) may correspond to a digital line configured to be rendered on a display, and wherein the parameter is one of: a line size, a line color, a line resolution, or a line type. One of ordinary skill in the art with the benefit of this disclosure would appreciate the many modifications, variations, and alternative embodiments thereof.

This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim.

The foregoing, together with other features and examples, will be described in more detail below in the following specification, claims, and accompanying drawings.

### BRIEF DESCRIPTION OF THE DRAWINGS

Aspects, features and advantages of embodiments of the present disclosure will become apparent from the following description of embodiments in reference to the appended drawings.

FIG. 1A shows a user operating a stylus device on a two-dimensional (2D) surface, according to certain embodiments.

FIG. 1B shows a user operating a stylus device in-air in a three-dimensional (3D) space, according to certain embodiments.

FIG. 2 shows a simplified block diagram of a system for operating an input device, according to certain embodiments.

FIG. 3 shows a number of input elements on an input device, according to certain embodiments.

FIG. 4 is a table that describes various functions that correspond to input elements on an input device, according to certain embodiments.

FIG. 5A is a table that presents a list of functions corresponding to certain input elements of an input device, according to certain embodiments.

FIG. 5B is a table that presents a list of functions corresponding to certain input elements of an input device, according to certain embodiments.

FIG. 6 shows a user holding and operating an input device in a typical manner, according to certain embodiments.

FIG. 7 shows an input device performing a function on a 2D surface, according to certain embodiments.

FIG. 8 shows an input device performing a function in 3D space, according to certain embodiments.

FIG. 9 shows an input device manipulating a rendered object in an AR/VR environment, according to certain embodiments.

FIG. 10 shows aspects of input detection and compensation on an input device, according to certain embodiments.

FIG. 11 shows a flow chart for a method of operating an input device, according to certain embodiments.

### DETAILED DESCRIPTION

Embodiments of this invention are generally directed to control devices configured to operate in AR/VR-based systems. More specifically, some embodiments relate to a stylus device with a novel design architecture having an improved user interface and control characteristics.

In the following description, for the purpose of explanation, numerous examples and details are set forth in order to provide an understanding of embodiments of the present invention. It will be evident, however, to one skilled in the art that certain embodiments can be practiced without some of these details, or with modifications or equivalents thereof.

To provide a high level, broad understanding of some aspects of the present disclosure, a non-limiting summary of certain embodiments are presented here. Stylus devices are often conventionally thought of as an input tool that can be used with a touchscreen-enabled device, such as tablet PCs, digital art tools, smart phones, or other device with an interactive surface, and can be used for navigating user interface elements. Early stylus devices were often passive (e.g., capacitive stylus) and were used similar to a finger where the electronic device simply detected contact on a touch-enabled surface. Active stylus devices can include electronic components that can electronically communicate with a host device. Stylus devices can often be manipulated similar to a conventional writing device, such as a pen or pencil, which can afford the user with familiarity in use, excellent control characteristics, and due to the ergonomics of such devices, allows the user to perform movements and manipulations with a high degree of control. This can be particularly apparent with respect to movements that may need a high level of precision and control, including actions such as drawing, painting, and writing when compared to other contemporary interfaces devices, such as gaming pads, joysticks, computer mice, presenter devices, or the like. Conventional stylus devices are typically used for providing user inputs, as described above, on a two-dimensional (2D) physical surface, such as a touch-sensitive pad or display. Embodiments of the present invention, as further described below, present an active stylus device that can be used to track both operations in and seamless transitions between physical 2D surfaces (e.g., touch sensitive or not) and three-dimensional (3D) in-air usage. Such embodiments may be used in virtual reality (VR), augmented reality (AR), mixed reality (MR), or real environments, as further described below.

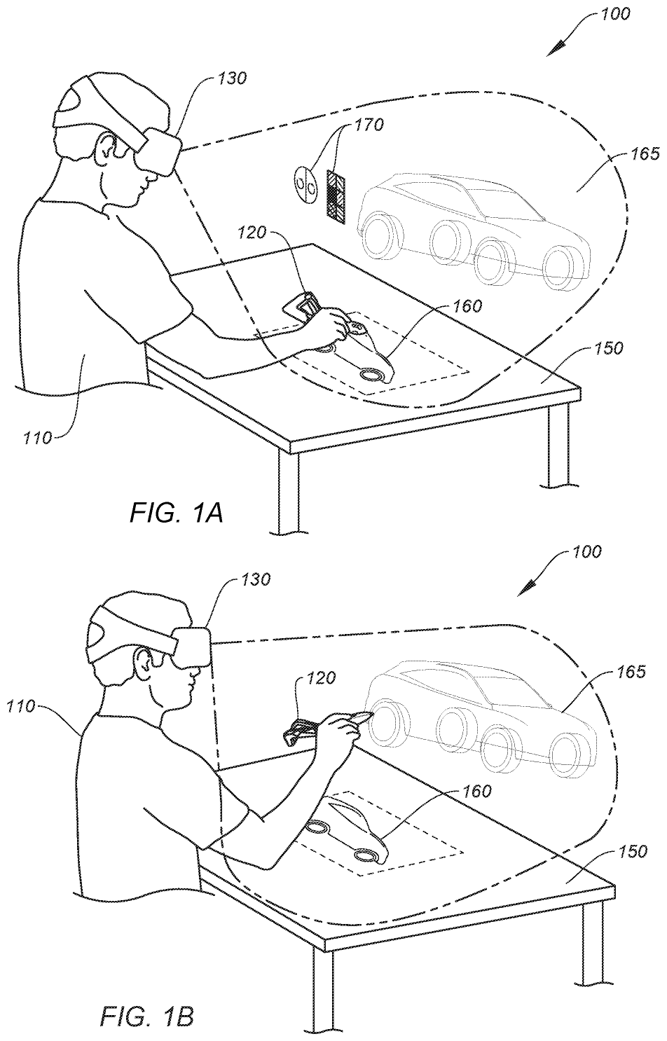

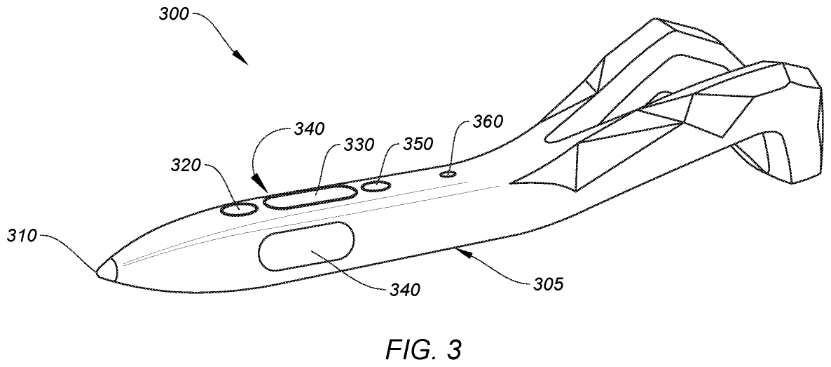

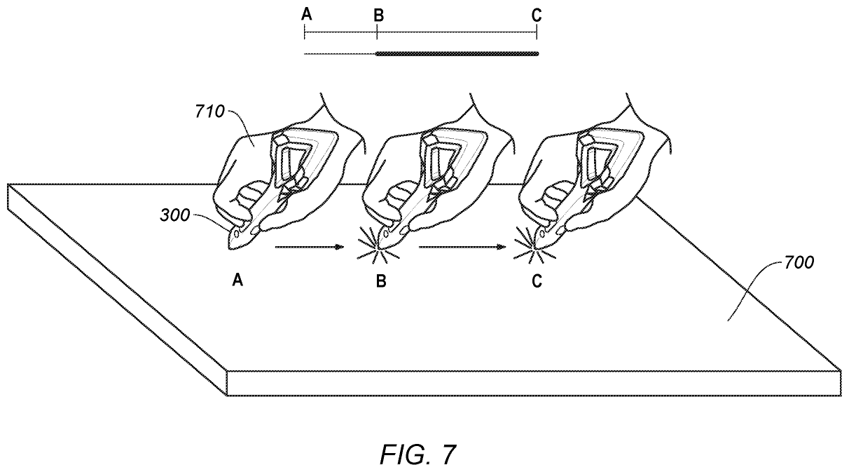

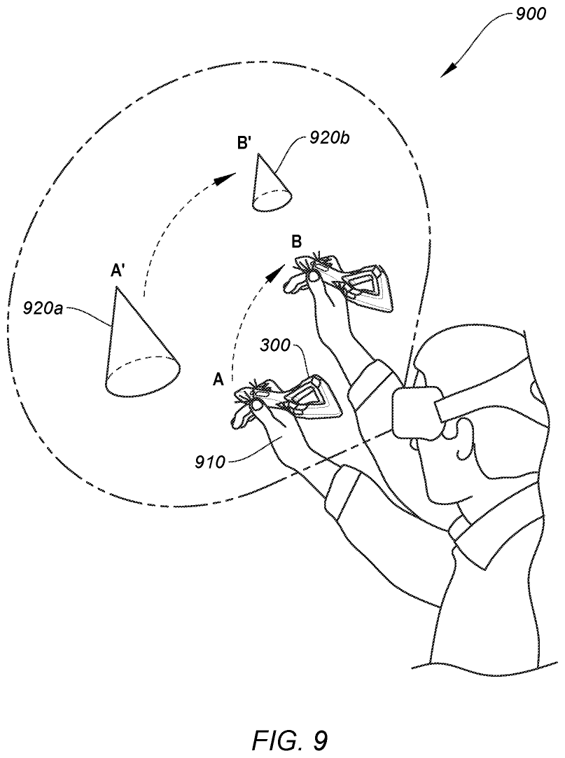

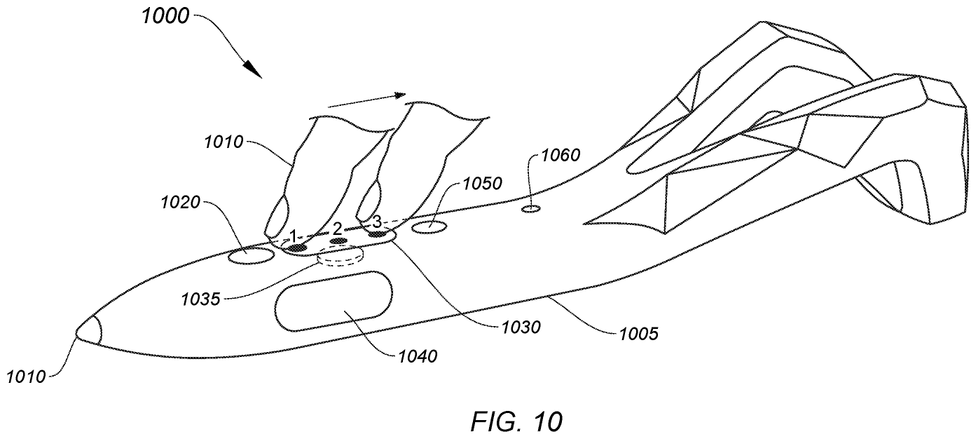

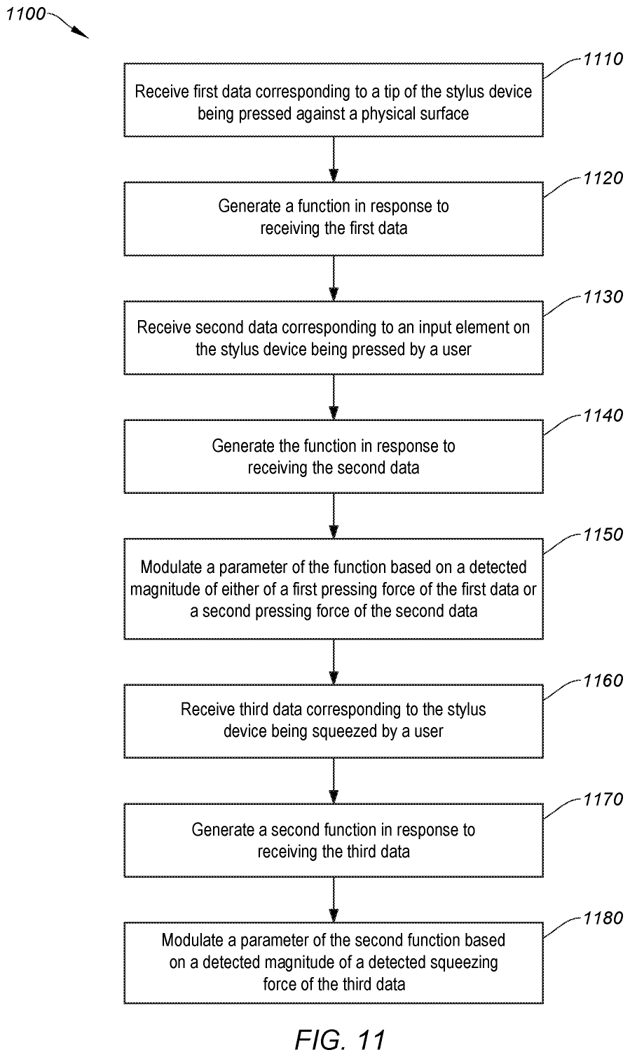

In some embodiments, a user can typically manipulate the stylus device with a high level of precision and physical motor control on a 2D surface, as one typically would when writing with a pen on a piece of paper on a physical surface (see, e.g., FIG. 1). However, with in-air usage, the user may find difficulty with holding their stylus hand steady in mid-air, drawing a precise digital line in a 3D environment, or even potentially more difficult, performing compound movements in mid-air without adversely affecting the user's level of precision and motor control (see, e.g., FIGS. 1B and 8-9). Certain embodiments can include a user interface (see, e.g., FIGS. 3-6) on the stylus device that is functionally and ergonomically designed to allow a user to perform such compound user movements and functions with greater precision and control. For example, a user may “grab” an object in a VR environment (or perform other suitable functions) by intuitively squeezing the sides of the stylus device (also referred to as “pinching” and what one may do when physically grabbing or picking up an object) to provide opposing forces using their thumb and middle/ring fingers, as shown in FIG. 9. The opposing forces may at least partially cancel each other art, resulting in a less likely introduction of an inadvertent movement of the stylus, which could occur when a typical depressible button is pushed because pressing it may introduce one or more forces on the stylus that can adversely affect the user's desired trajectory (e.g., while the user is drawing a line in-air). In some embodiments, certain buttons may include load cells to detect buttons presses over a range of forces, but without physical movement of the button, which could otherwise introduce unwanted forces during stylus use (see, e.g., FIG. 7). Aspects of the invention may further include an intuitive interface for switching between input elements as the stylus transitions between 2D and 3D environments (see, e.g., FIG. 11) and a touch sensitive touch pad configured to compensate touch sensing measurements to improve accuracy (see, e.g., FIG. 10). It should be noted that while many of the embodiments and figures that follow show a stylus device used in an AR/VR environment, it should be understood that such embodiments may be used in non-AR/VR environments as well, as would be appreciated by one of ordinary skill in the art with the benefit of this disclosure. Aspects of AR/VR systems are further described below as well as in related U.S. application Ser. No. 16/054,944, filed on Aug. 3, 2018, and titled “Input Device for Use in an Augmented/Virtual Reality Environment,” which is hereby incorporated by reference in its entirety for all purposes, as indicated above. Some or all aspects of said U.S. application may be applied to the embodiments herein, including aspects such as the general shape of the stylus device, tracking schemes (e.g., 6 DOF tracking in an AR/VR environment), etc., as would be appreciated by one of ordinary skill in the art with the benefit of this disclosure and disclosure incorporated by reference identified above.

### Definitions

The present disclosure may be better understood in view of the following explanations:

As used herein, the terms “computer simulation” and “virtual reality environment” may refer to a virtual reality, augmented reality, mixed reality, or other form of visual, immersive computer-simulated environment provided to a user. As used herein, the terms “virtual reality” or “VR” may include a computer-simulated environment that replicates an imaginary setting. A physical presence of a user in this environment may be simulated by enabling the user to interact with the setting and any objects depicted therein. Examples of VR environments may include: a video game; a medical procedure simulation program including a surgical or physiotherapy procedure; an interactive digital mock-up of a designed feature, including a computer aided design; an educational simulation program, including an E-leaning simulation; or other like simulation. The simulated environment may be two or three-dimensional.

As used herein, the terms “augmented reality” or “AR” may include the use of rendered images presented in conjunction with a real-world view. Examples of AR environments may include: architectural applications for visualization of buildings in the real-world; medical applications for augmenting additional information to a user during surgery or therapy; gaming environments to provide a user with an augmented simulation of the real-world prior to entering a VR environment.

As used herein, the terms “mixed reality” or “MR” may include use of virtual objects that are rendered as images in conjunction with a real-world view of an environment wherein the virtual objects can interact with the real world environment. Embodiments described below can be implemented in AR, VR, or MR environments.

As used herein, the term “real-world environment” or “real-world” may refer to the physical world (also referred to herein as “physical environment.” Hence, term “real-world arrangement” with respect to an object (e.g., a body part or user interface device) may refer to an arrangement of the object in the real-world and may be relative to a reference point. The term “arrangement” with respect to an object may refer to a position (location and orientation). Position can be defined in terms of a global or local coordinate system.

As used herein, the term “rendered images” or “graphical images” may include images that may be generated by a computer and displayed to a user as part of a virtual reality environment. The images may be displayed in two or three dimensions. Displays disclosed herein can present images of a real-world environment by, for example, enabling the user to directly view the real-world environment and/or present one or more images of a real-world environment (that can be captured by a camera, for example).

As used herein, the term “head mounted display” or “HMD” may refer to a display to render images to a user. The HMD may include a graphical display that is supported in front of part or all of a field of view of a user. The display can include transparent, semi-transparent or non-transparent displays. The HMD may be part of a headset. The graphical display of the HMD may be controlled by a display driver, which may include circuitry as defined herein.

As used herein, the term “electrical circuitry” or “circuitry” may refer to, be part of, or include one or more of the following or other suitable hardware or software components: a processor (shared, dedicated, or group); a memory (shared, dedicated, or group), a combinational logic circuit, a passive electrical component, or an interface. In certain embodiment, the circuitry may include one or more virtual machines that can provide the described functionality. In certain embodiments, the circuitry may include passive components, e.g. combinations of transistors, transformers, resistors, capacitors that may provide the described functionality. In certain embodiments, the circuitry may be implemented using, or functions associated with the circuitry may be implemented using, one or more software or firmware modules. In some embodiments, circuitry may include logic, at least partially operable in hardware. The electrical circuitry may be centralized or distributed, including being distributed on various devices that form part of or are in communication with the system and may include: a networked-based computer, including a remote server; a cloud-based computer, including a server system; or a peripheral device.

As used herein, the term “processor(s)” or “host/local processor(s)” or “processing resource(s)” may refer to one or more units for processing including an application specific integrated circuit (ASIC), central processing unit (CPU), graphics processing unit (GPU), programmable logic device (PLD), microcontroller, field programmable gate array (FPGA), microprocessor, digital signal processor (DSP), or other suitable component. A processor can be configured using machine readable instructions stored on a memory. The processor may be centralized or distributed, including distributed on various devices that form part of or are in communication with the system and may include: a networked-based computer, including a remote server; a cloud-based computer, including a server system; or a peripheral device. The processor may be arranged in one or more of: a peripheral device (e.g., a stylus device), which may include a user interface device and/or an HMD; a computer (e.g., a personal computer or like device); or other device in communication with a computer system.

As used herein, the term “computer readable medium/media” may include conventional non-transient memory, for example, random access memory (RAM), an optical media, a hard drive, a flash drive, a memory card, a floppy disk, an optical drive, and/or combinations thereof. It is to be understood that while one or more memories may be located in the same physical location as the system, the one or more memories may be located remotely from the host system, and may communicate with the one or more processor via a computer network. Additionally, when more than one memory is used, a first memory may be located in the same physical location as the host system and additional memories may be located in a remote physical location from the host system. The physical location(s) of the one or more memories may be varied. Additionally, one or more memories may be implemented as a “cloud memory” (i.e., one or more memory may be partially or completely based on or accessed using the network).

As used herein, the term “communication resources” may refer to hardware and/or firmware for electronic information transfer. Wireless communication resources may include hardware to transmit and receive signals by radio, and may include various protocol implementations, e.g., 802.11 standards described in the Institute of Electronics Engineers (IEEE), Bluetooth™, ZigBee, Z-Wave, Infra-Red (IR), RF, or the like. Wired communication resources may include; a modulated signal passed through a signal line, said modulation may accord to a serial protocol such as, for example, a Universal Serial Bus (USB) protocol, serial peripheral interface (SPI), inter-integrated circuit (I2C), RS-232, RS-485, or other protocol implementations.

As used herein, the term “network” or “computer network” may include one or more networks of any type, including a Public Land Mobile Network (PLMN), a telephone network (e.g., a Public Switched Telephone Network (PSTN) and/or a wireless network), a local area network (LAN), a metropolitan area network (MAN), a wide area network (WAN), an Internet Protocol Multimedia Subsystem (IMS) network, a private network, the Internet, an intranet, and/or another type of suitable network.

As used herein, the term “sensor system” may refer to a system operable to provide position information concerning input devices, peripherals, and other objects in a physical world that may include a body part or other object. The term “tracking system” may refer to detecting movement of such objects. The body part may include an arm, leg, torso, or subset thereof including a hand or digit (finger or thumb). The body part may include the head of a user. The sensor system may provide position information from which a direction of gaze and/or field of view of a user can be determined. The object may include a peripheral device interacting with the system. The sensor system may provide a real-time stream of position information. In an embodiment, an image stream can be provided, which may represent an avatar of a user. The sensor system and/or tracking system may include one or more of a: camera system; a magnetic field based system; capacitive sensors; radar; acoustic; other suitable sensor configuration, optical, radio, magnetic, and inertial technologies, such as lighthouses, ultrasonic, IR/LEDs, SLAM tracking, light detection and ranging (LIDAR) tracking, ultra-wideband tracking, and other suitable technologies as understood to one skilled in the art. The sensor system may be arranged on one or more of: a peripheral device, which may include a user interface device, the HMD; a computer (e.g., a P.C., system controller or like device); other device in communication with the system.

As used herein, the term “camera system” may refer to a system comprising a single instance or a plurality of cameras. The camera may comprise one or more of: a 2D camera; a 3D camera; an infrared (IR) camera; a time of flight (ToF) camera. The camera may include a complementary metal-oxide-semiconductor (CMOS), a charge-coupled device (CCD) image sensor, or any other form of optical sensor in use to form images. The camera may include an IR filter, which can be used for object tracking. The camera may include a red-green-blue (RGB) camera, which may be used for generation of real world images for augmented or mixed reality simulations. In an embodiment different frames of a single camera may be processed in an alternating manner, e.g., with an IR filter and for RGB, instead of separate cameras. Images of more than one camera may be stitched together to give a field of view equivalent to that of the user. A camera system may be arranged on any component of the system. In an embodiment the camera system is arranged on a headset or HMD, wherein a capture area of the camera system may record a field of view of a user. Additional cameras may be arranged elsewhere to track other parts of a body of a user. Use of additional camera(s) to cover areas outside the immediate field of view of the user may provide the benefit of allowing pre-rendering (or earlier initiation of other calculations) involved with the augmented or virtual reality rendition of those areas, or body parts contained therein, which may increase perceived performance (e.g., a more immediate response) to a user when in the virtual reality simulation. The camera system may provide information, which may include an image stream, to an application program, which may derive the position and orientation therefrom. The application program may implement known techniques for object tracking, such as feature extraction and identification.

As used herein, the term “user interface device” may include various devices to interface a user with a computer, examples of which include: pointing devices including those based on motion of a physical device, such as a mouse, trackball, joystick, keyboard, gamepad, steering wheel, paddle, yoke (control column for an aircraft) a directional pad, throttle quadrant, pedals, light gun, or button; pointing devices based on touching or being in proximity to a surface, such as a stylus, touchpad or touch screen; or a 3D motion controller. The user interface device may include one or more input elements. In certain embodiments, the user interface device may include devices intended to be worn by the user. Worn may refer to the user interface device supported by the user by means other than grasping of the hands. In many of the embodiments described herein, the user interface device is a stylus-type device for use in an AR/VR environment.

As used herein, the term “IMU” may refer to an Inertial Measurement Unit which may measure movement in six Degrees of Freedom (6 DOF), along x, y, z Cartesian coordinates and rotation along 3 axes—pitch, roll and yaw. In some cases, certain implementations may utilize an IMU with movements detected in fewer than 6 DOF (e.g., 3 DOF as further discussed below).

As used herein, the term “keyboard” may refer to an alphanumeric keyboard, emoji keyboard, graphics menu, or any other collection of characters, symbols or graphic elements. A keyboard can be a real world mechanical keyboard, or a touchpad keyboard such as a smart phone or tablet On Screen Keyboard (OSK). Alternately, the keyboard can be a virtual keyboard displayed in an AR/MR/VR environment.

As used herein, the term “fusion” may refer to combining different position-determination techniques and/or position-determination techniques using different coordinate systems to, for example, provide a more accurate position determination of an object. For example, data from an IMU and a camera tracking system, both tracking movement of the same object, can be fused. A fusion module as describe herein performs the fusion function using a fusion algorithm. The fusion module may also perform other functions, such as combining location or motion vectors from two different coordinate systems or measurement points to give an overall vector.

Note that certain embodiments of input devices described herein often refer to a “bottom portion” and a “top portion,” as further described below. Note that the bottom portion (the portion typically held by a user) can also be referred to as a “first portion” and both terms are interchangeable. Likewise, the top portion (the portion typically including the sensors and/or emitters) can be referred to as the “second portion,” which are also interchangeable.

### Typical Use of Certain Embodiments

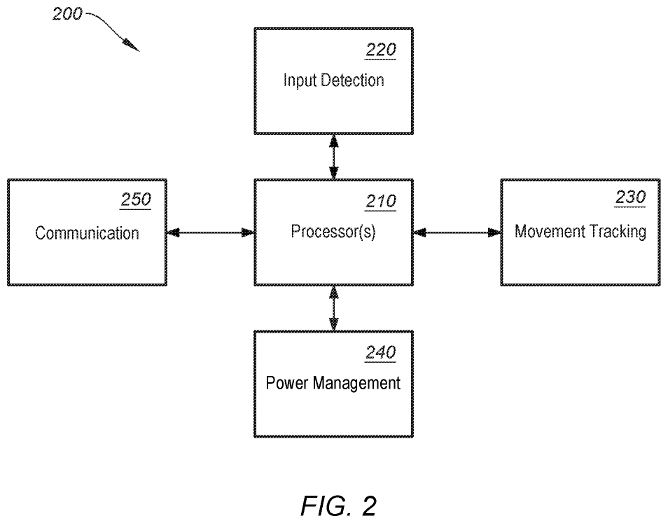

In certain embodiments, a stylus device can be configured with novel interface elements to allow a user to operate within and switch between 2D and 3D environments in an intuitive manner. To provide a simplified example of a typical use case, FIG. 1A shows a user 110 operating an input device 120 (e.g., a stylus device) in an AR/VR environment 100, according to certain embodiments. A head-mounted display (HMD) 130 can be configured to render the AR/VR environment 100 and the various interfaces and objects therein, as described below. User 110 is shown to be editing a 2D illustration 160 of an A-line for a rendered vehicle using input device 120 (e.g., a side elevation view of the rendered vehicle. The edits of the 2D illustration 160 are shown to update a 3D model 165 of the vehicle (e.g., in real-time) rendered in-air in front of user 110. Various editing controls 170 are shown that allow a user to control various functions of input device 120 including, but not limited to, line font, line width, line color, textures, or other myriad possible functions, as would be appreciated by one of ordinary skill in the art with the benefit of this disclosure. In FIG. 1B, user 110 is shown operating input device 120 in-air and editing the 3D model 165 of the rendered vehicle in 3D space, according to certain embodiments. Although not shown (to prevent the obfuscation of the more pertinent aspects of embodiments of the invention), AR/VR environment 100 can include a computer and any number of peripheral devices, including other display devices, computer mice, keyboards, or other input and/or output devices, in addition to input device 120. Input device can be tracked and may be in wireless electronic communication with one or more external sensors, HMD 130, a host computing device, or any combination thereof. Similarly, HMD 130 can be in wireless electronic communication with one or more external sensors, a host computer, stylus 130, or any combination thereof. One of ordinary skill in the art with the benefit of this disclosure would understand the many variations, modifications, and alternative embodiments thereof for tracking stylus 120 with the various types of AR/VR tracking systems in use. Some of the novel input elements that allow user to operate in both 2D and 3D environments and transition between the two in an intuitive manner are described below at least with respect to FIGS. 2-11.

### Simplified System Embodiment for an Input Device

FIG. 2 shows a simplified system block diagram (“system”) 200 for operating an input device 120, according to certain embodiments. System 200 may include processor(s) 210, input detection block 220, movement tracking block 230, power management block 240, and communication block 250. Each of system blocks 220-250 can be in electrical communication with processor(s) 210. System 200 may further include additional systems that are not shown or described to prevent obfuscation of the novel features described herein, but would be expected by one of ordinary skill in the art with the benefit of this disclosure.

In certain embodiments, processor(s) 210 may include one or more microprocessors (μCs) and can be configured to control the operation of system 200. Alternatively or additionally, processor 210 may include one or more microcontrollers (MCUs), digital signal processors (DSPs), or the like, with supporting hardware, firmware (e.g., memory, programmable I/Os, etc.), and/or software, as would be appreciated by one of ordinary skill in the art. Alternatively, MCUs, μCs, DSPs, ASIC, programmable logic device, and the like, may be configured in other system blocks of system 200. For example, communications block 250 may include a local processor to control communication with computer 140 (e.g., via Bluetooth, Bluetooth LE, RF, IR, hardwire, ZigBee, Z-Wave, Logitech Unifying, or other communication protocol). In some embodiments, multiple processors may enable increased performance characteristics in system 200 (e.g., speed and bandwidth), however multiple processors are not required, nor necessarily germane to the novelty of the embodiments described herein. Alternatively or additionally, certain aspects of processing can be performed by analog electronic design, as would be understood by one of ordinary skill in the art.

Input detection block 220 can control the detection of button activation (e.g., the controls described below with respect to FIGS. 3-5B), scroll wheel and/or trackball manipulation (e.g., rotation detection), sliders, switches, touch sensors (e.g., one and/or two-dimensional touch pads), force sensors (e.g., nib and corresponding force sensor 310, button and corresponding force sensor 320), and the like. An activated input element (e.g., button press) may generate a corresponding control signal (e.g., human interface device (HID) signal) to control a computing device (e.g., a host computer) communicatively coupled to input device 110 (e.g., instantiating a “grab” function in the AR/VR environment via element(s) 340). Alternatively, the functions of input detection block 220 can be subsumed by processor 210, or in combination therewith. In some aspects, button press detection may be detected by a one or more sensors (also referred to as a sensor set), such as a load cell coupled to a button (or other surface feature). A load cell can be controlled by processor(s) 210 and configured to detect an amount of force applied to the button or other input element coupled to the load cell. One example of a load cell is a strain gauge load cell (e.g., a planar resistor) that can be deformed. Deformation of the strain gauge load cell can change its electrical resistance by an amount that can be proportional to the amount of strain, which can cause the load cell to generate an electrical value change that is proportional to the load placed on the load cell. Load cells may be coupled to any of the input elements (e.g., tip 310, analog button 320, grip buttons 340, touch pad 330, menu button 350, system button 360, etc.) described herein.

In some embodiments, the load cell may be a piezo-type. Preferentially, the load cell should have a wide operating range to detect very light forces for high sensitivity detection (e.g., down to approximately 1 gram) to relatively heavy forces (e.g., up to 5+ Newtons). It is common place for a conventional tablet stylus to use up to 500 g on the tablet surface. However, in VR use (e.g., writing on a VR table or a physical whiteboard while wearing a VR HMD), typical forces may be much higher, thus 5+ Newton detection is preferable. In some embodiments, a load cell coupled to the nib (e.g., tip 310) may have an activation force that may range from 1 g to 10 g, which may be a default setting or set/tuned by a user via software/firmware settings. In some cases, a load cell coupled to the primary analog button (button 320) may be configured with an activation force of 30 g (typically activated by the index finger). These examples are typical activation force settings, however any suitable activation force may be set as would be appreciated by one of ordinary skill in the art with the benefit of this disclosure. By comparison, 60-70 g are typically used for a mouse button click on a gaming mouse, and 120 g or more may be used to activate a button click function under a scroll wheel. A typical load cell size may be 4 mm×2.6 mm×2.06 mmt, although other dimensions can be used.

In some embodiments, input detection block 220 can detect a touch or touch gesture on one or more touch sensitive surfaces (e.g., touch pad 330). Input detection block 220 can include one or more touch sensitive surfaces or touch sensors. Touch sensors generally comprise sensing elements suitable to detect a signal such as direct contact, electromagnetic or electrostatic fields, or a beam of electromagnetic radiation. Touch sensors can typically detect changes in a received signal, the presence of a signal, or the absence of a signal. A touch sensor may include a source for emitting the detected signal, or the signal may be generated by a secondary source. Touch sensors may be configured to detect the presence of an object at a distance from a reference zone or point (e.g., <5 mm), contact with a reference zone or point, or a combination thereof. Certain embodiments of input device 120 may or may not utilize touch detection or touch sensing elements.

In some aspects, input detection block 220 can control the operating of haptic devices implemented on an input device. For example, input signals generated by haptic devices can be received and processed by input detection block 220. For example, an input signal can be an input voltage, charge, or current generated by a load cell (e.g., piezoelectric device) in response to receiving a force (e.g., user touch) on its surface. In some embodiments, input detection block 220 may control an output of one or more haptic devices on input device 120. For example, certain parameters that define characteristics of the haptic feedback can be controlled by input detection block 220. Some input and output parameters can include a press threshold, release threshold, feedback sharpness, feedback force amplitude, feedback duration, feedback frequency, over voltage (e.g., using different voltage levels at different stages), and feedback modulation over time. Alternatively, haptic input/output control can be performed by processor 210 or in combination therewith.

Input detection block 220 can include touch and/or proximity sensing capabilities. Some examples of the types of touch/proximity sensors may include, but are not limited to, resistive sensors (e.g., standard air-gap 4-wire based, based on carbon loaded plastics which have different electrical characteristics depending on the pressure (FSR), interpolated FSR, etc.), capacitive sensors (e.g., surface capacitance, self-capacitance, mutual capacitance, etc.), optical sensors (e.g., infrared light barriers matrix, laser based diode coupled with photo-detectors that could measure the time-of-flight of the light path, etc.), acoustic sensors (e.g., piezo-buzzer coupled with microphones to detect the modification of a wave propagation pattern related to touch points, etc.), or the like.

Movement tracking block 230 can be configured to track or enable tracking of a movement of input device 120 in three dimensions in an AR/VR environment. For outside-in tracking systems, movement tracking block 230 may include a plurality of emitters (e.g., IR LEDs) disposed on an input device, fiducial markings, or other tracking implements, to allow the outside-in system to track the input device's position, orientation, and movement within the AR/VR environment. For inside-out tracking systems, movement tracking block 230 can include a plurality of cameras, IR sensors, or other tracking implements to allow the inside-out system track the input device's position, orientation, and movement within the AR/VR environment. Preferably, the tracking implements (also referred to as “tracking elements”) in either case are configured such that at least four reference points on the input device can be determined at any point in time to ensure accurate tracking. Some embodiments may include emitters and sensors, fiducial markings, or other combination of multiple tracking implements such that the input device may be used “out of the box” in an inside-out-type tracking system or an outside-in-type tracking system. Such embodiments can have a more universal, system-agnostic application across multiple system platforms.

In certain embodiments, an inertial measurement unit (IMU) can be used for supplementing movement detection. IMUs may be comprised of one or more accelerometers, gyroscopes, or the like. Accelerometers can be electromechanical devices (e.g., micro-electromechanical systems (MEMS) devices) configured to measure acceleration forces (e.g., static and dynamic forces). One or more accelerometers can be used to detect three dimensional (3D) positioning. For example, 3D tracking can utilize a three-axis accelerometer or two two-axis accelerometers. Accelerometers can further determine a velocity, physical orientation, and acceleration of input device 120 in 3D space In some embodiments, gyroscope(s) can be used in lieu of or in conjunction with accelerometer(s) to determine movement or input device orientation in 3D space (e.g., as applied in an VR/AR environment). Any suitable type of IMU and any number of IMUs can be incorporated into input device 120, as would be understood by one of ordinary skill in the art. Movement tracking for input device 120 is described in further detail in U.S. application Ser. No. 16/054,944, as noted above.

Power management block 240 can be configured to manage power distribution, recharging, power efficiency, and the like, for input device 120. In some embodiments, power management block 240 can include a battery (not shown), a USB-based recharging system for the battery (not shown), and a power grid within system 200 to provide power to each subsystem (e.g., communications block 250, etc.). In certain embodiments, the functions provided by power management block 240 may be incorporated into processor(s) 210. Alternatively, some embodiments may not include a dedicated power management block. For example, functional aspects of power management block 240 may be subsumed by another block (e.g., processor(s) 210) or in combination therewith.

Communications block 250 can be configured to enable communication between input device 120 and HMD 160, a host computer (not shown), or other devices and/or peripherals, according to certain embodiments. Communications block 250 can be configured to provide wireless connectivity in any suitable communication protocol (e.g., radio-frequency (RF), Bluetooth, BLE, infra-red (IR), ZigBee, Z-Wave, Logitech Unifying, or a combination thereof).

Although certain systems may not expressly discussed, they should be considered as part of system 200, as would be understood by one of ordinary skill in the art. For example, system 200 may include a bus system to transfer power and/or data to and from the different systems therein. In some embodiments, system 200 may include a storage subsystem (not shown). A storage subsystem can store one or more software programs to be executed by processors (e.g., in processor(s) 210). It should be understood that “software” can refer to sequences of instructions that, when executed by processing unit(s) (e.g., processors, processing devices, etc.), cause system 200 to perform certain operations of software programs. The instructions can be stored as firmware residing in read only memory (ROM) and/or applications stored in media storage that can be read into memory for processing by processing devices. Software can be implemented as a single program or a collection of separate programs and can be stored in non-volatile storage and copied in whole or in-part to volatile working memory during program execution. From a storage subsystem, processing devices can retrieve program instructions to execute in order to execute various operations (e.g., software-controlled spring auto-adjustment, etc.) as described herein.

It should be appreciated that system 200 is meant to be illustrative and that many variations and modifications are possible, as would be appreciated by one of ordinary skill in the art. System 200 can include other functions or capabilities that are not specifically described here (e.g., mobile phone, global positioning system (GPS), power management, one or more cameras, various connection ports for connecting external devices or accessories, etc.). While system 200 is described with reference to particular blocks (e.g., input detection block 220), it is to be understood that these blocks are defined for understanding certain embodiments of the invention and is not intended to imply that embodiments are limited to a particular physical arrangement of component parts. The individual blocks need not correspond to physically distinct components. Blocks can be configured to perform various operations, e.g., by programming a processor or providing appropriate processes, and various blocks may or may not be reconfigurable depending on how the initial configuration is obtained. Certain embodiments can be realized in a variety of apparatuses including electronic devices implemented using any combination of circuitry and software. Furthermore, aspects and/or portions of system 200 may be combined with or operated by other sub-systems as informed by design. For example, power management block 240 and/or movement tracking block 230 may be integrated with processor(s) 210 instead of functioning as a separate entity.

### Certain Embodiments of a User Interface on an Input Device

Aspects of the invention present a novel user interface that allows a user to manipulate input device 120 with a high level of precision and physical motor control on both a 2D surface and in in-air 3D movements. Input device 120 may be typically used in an AR/VR environment, however use in non-AR/VR environments are possible (e.g., drawing on a surface of a tablet computer, drawing in-air with tracked inputs shown on a monitor or other display, etc.). FIGS. 3-6 show various input elements on an input device (e.g., shown as a stylus device) that is functionally and ergonomically designed to allow a user to perform such compound user movements and functions with greater precision and control.

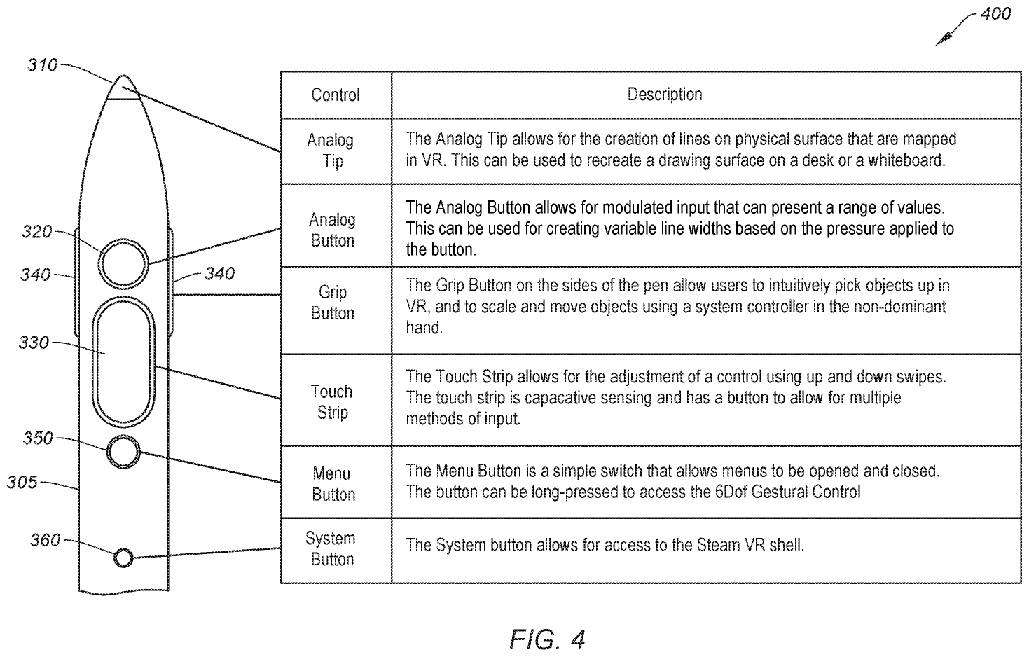

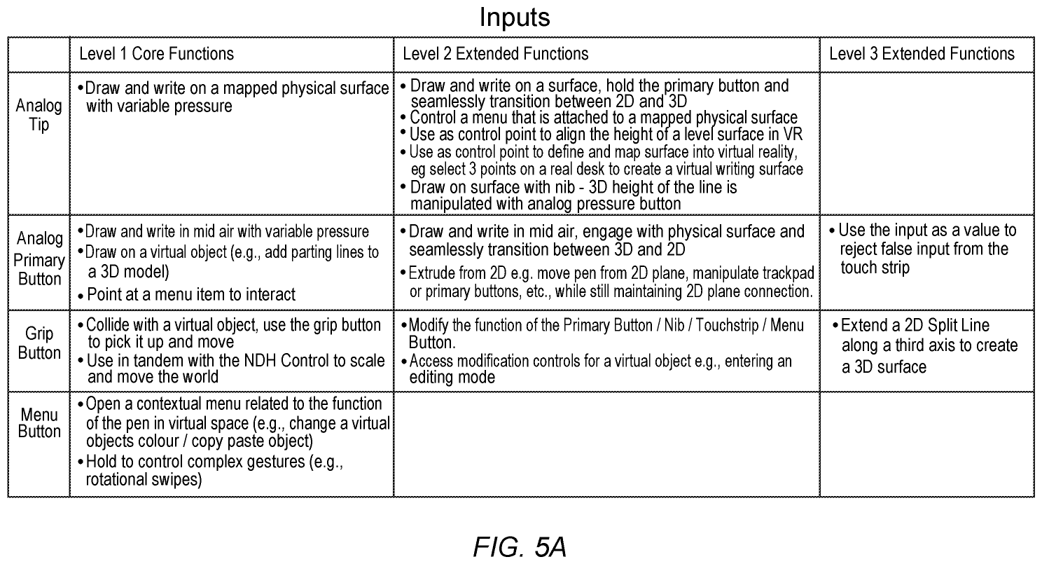

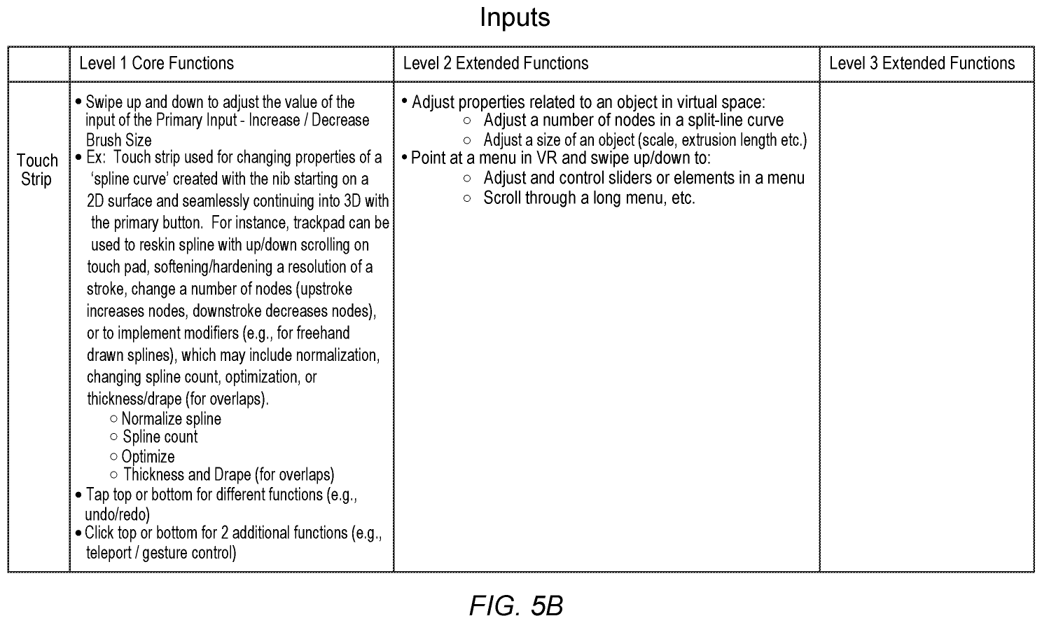

FIG. 3 shows a number of input elements (310-360) configured on a housing 305 of an input device 300, according to certain embodiments. Housing 305 can include a tip or “nib” 310, a button 320 (also referred to as “analog button 310” and “primary button 310”), a touch-sensitive sensor 330, one or two “grip” buttons 340, a menu button 350, and a system button 360. More input elements (e.g., such as an integrated display, microphone, speaker, haptic motor, etc.) or fewer input elements (e.g., embodiments limited to a subset of input elements 310-360 in any ordered combination) are possible. In some aspects, the input elements of input device 300 and other embodiments of input devices described throughout this disclosure may be controlled by input detection block 220, processor(s) 210, other system blocks, or any combination thereof. Tables 400, 500a, and 500b of FIGS. 4, 5A, and 5B, respectively, provide a description of a non-limiting list of functions that can be performed by the input elements enumerated above. Input device 300 may be similar in shape, size, and/or functionality as input device 120 of FIG. 1, and may be operated by aspects of system 200 of FIG. 2, as would be appreciated by one of ordinary skill in the art with the benefit of this disclosure.

In some embodiments, tip 310 may be configured at an end of housing 305, as shown in FIGS. 3 and 4, according to certain embodiments. Tip 310 (also referred to as an “analog tip” or “nib”) can be used for the generation of virtual lines on a physical surface that can be mapped in an AR/VR space. Tip 310 may include one or more sensors (also referred to as a “sensor set”) coupled to tip 310 to detect a pressing force when tip 310 is pressed against a physical surface, such as a table, tablet display, desk, or other surface. The surface can be planar, curved, smooth, rough, polygonal, or of suitable shape or texture. In some embodiments, the one or more sensors may include a load cell (described above with respect to FIG. 2) configured to detect the pressing force imparted by the surface on tip 310. In some embodiments, the sensor set may generate an analog signal (e.g., a voltage, current, etc.) the is proportional to the amount of force. In some cases, a threshold force (also referred to as an “activation force”) may be used to trigger a first function (e.g., instantiate a drawing/writing function) and a second higher threshold force may trigger one or more additional functions (e.g., greater line thickness (point)). In some embodiments, an activation force for the tip 310 may be set to less than 10 g for more precise movements and articulations, although higher activation forces (e.g., 20-30 g) may be appropriate for general non-precision use. The higher threshold force to, for example, switch from a thin line to a thick line, may be set at an appropriate interval higher than the initial activation force that is not prone to inadvertently activate. For example, the second higher threshold activation force may be 20-30 g higher than the first activation force. For instance, a first threshold (activation) force may be 10 g and a second threshold force may be set to 40 g. Other activation forces can be used, which may be set by default or tuned by a user. In some cases, machine learning may be used to determine a user's preferences over time, which can be used to tune the various activation forces for load cells. One of ordinary skill in the art with the benefit of this disclosure would appreciate the many types of functions, threshold levels, etc., that could be applied.

In certain embodiments, the function(s) of tip 310 can be combined with other input elements of input device 300. Typically, when the user removes input device 300 from a 2D surface, the writing/drawing function may cease as tip 310 and its corresponding sensor set no longer detects a pressing force imparted by the 2D surface on tip 310. This may be problematic when the user wants to move from the 2D surface to drawing in 3D space (e.g., as rendered by an HMD) in a smooth, continuous fashion. In some embodiments, the user may hold primary button 320 (configured to detect a pressing force typically provided by a user, as further described below) while drawing/writing on the 2D surface and as input device 300 leaves the surface (with primary button 320 being held), the writing/drawing function can be maintained such that the user can seamlessly transition between the 2D surface to 3D (in-air) drawing/writing in a continuous and uninterrupted fashion.

As indicated above, tip 310 can include analog sensing to detect a variable pressing force over a range of values. Multiple thresholds may be employed to employ multiple functions. For example, a detected pressure on tip 310 below a first threshold may not implement a function (e.g., the user is moving input device 300 along a mapped physical surface but does not intend to write), a detected force above the first threshold may implement a first function (e.g., writing), and detected force above the first threshold may modulate a thickness (font point size) of a line or brush tool. In some embodiments, other typical functions associated with tip 310 can include controlling a virtual menu that is associated to a mapped physical surface; using a control point to align the height of a level surface in a VR environment; using a control point to define and map a physical surface into virtual reality, for example, by selecting select three points on a physical desk (e.g., using tip 310) to create a virtual writing surface in VR space; and drawing on a physical surface with tip 310 (the nib), but with a 3D rendered height of a corresponding line (or thickness, font size, etc.) being modulated by a detected analog pressure on main button 320, or the like. An example of writing or drawing on a physical surface that is mapped to a virtual surface may involve a user pressing a tip 310 of stylus 300 against a table. In some aspects, a host computing device may register the surface of the tablet with a virtual table rendered in VR such that a user interacting with the virtual table would be interacting with a real world surface. One of ordinary skill in the art with the benefit of this disclosure would appreciate the many modifications, variations, and alternative embodiments thereof.

Analog button 320 may be coupled to and/or integrated with a surface of housing 305 and may be configured to allow for a modulated input that can present a range of values corresponding to an amount of force (referred to as a “pressing force”) that is applied to it. The pressing force may be detected by a sensor set, such as one or more load cells configured output a proportional analog input. Analog button 320 is typically interfaced by a user's index finger, although other interface schemes are possible (e.g., other digits may be used). In some embodiments, a varying force may be applied to analog button 320, which can be used to modulate a function, such as drawing and writing in-air (e.g., tracking in a physical environment and rendering in an AR/VR environment), where the varying pressure (e.g., pressing force) can be used to generate variable line widths, for instance (e.g., an increase in a detected pressing force may result in an increase in line width). In some implementations, analog button 320 may be used in a binary fashion where a requisite pressing force causes a line to be rendered while operating in-air with no variable force dependent modulation. In some cases, a user may press button 320 to draw on a virtual object (e.g., add parting lines to a 3D model), select a menu item on a virtual user interface, start/stop writing/drawing during in-air use, etc.

In some embodiments, analog button 320 can be used in conjunction with other input elements to implement certain functionality in input device 300. As described above, analog button 320 may be used in conjunction with tip 310 to seamlessly transition a rendered line on a 2D physical surface (e.g., the physical surface detected by a sensor set of tip 310) to 3D in-air use (e.g., a sensor set associated with analog button 320 detecting a pressing force). In some implementations, analog button 320 may be used to add functionality on a 2D environment. For example, an extrusion operation (e.g., extruding a surface contour of a rendered object) may be performed when analog button 320 is pressed while moving from a 2D surface of a rendered virtual object to a location in 3D space a distance from the 2D surface, which may result in the surface contour of the rendered 2D surface to be extruded to the location in 3D space.

In some cases, an input on analog button 320 may be used to validate or invalidate other inputs. For instance, a detected input on touch pad 330 (further described below) may be intentional (e.g., a user is navigating a menu or adjusting a parameter of a function associated with input device 300 in an AR/VR environment) or unintentional (e.g., a user accidentally contacts a surface of touch pad 330 while intending to interface with analog button 320). Thus, some embodiments of input device 300 may be configured to process an input on analog button 320 and ignore a contemporaneous input on touch pad 330 or other input element (e.g., menu button 350, system button 360, etc.) that would typically be interfaced by, for example, the same finger while input device 200 is in use (e.g., a user's index finger). As such, contemporaneous use of analog button 320 and grip buttons 340 (e.g., typically accessed by at least one of a thumb and middle/ring fingers) may be expected and processed accordingly as these input elements are typically interfaced with different fingers. Other functions and the myriad possible combinations of contemporaneous use of the input elements are possible, as would be appreciated by one of ordinary skill in the art with the benefit of this disclosure.

In some embodiments, analog button 320 may not be depressible, although the corresponding sensor set (e.g., underlying load cell) may be configured to detect a pressing force on imparted on analog button 320. The non-depressible button may present ergonomic advantages, particularly for more sensitive applications of in-air use of input device 300. To illustrate, consider that a user's hand may be well supported while using a pen or paint brush on a 2D surface, as the user's hand and/or arm can brace against the surface to provide support for precise articulation and control. Input device 300 can be used in a similar manner, as shown in FIG. 1A. However, a user's hand or arm is typically not supported when suspended in-air, as shown in FIG. 1B. Thus, it may be more challenging for a user to hold their hand steady or perform smooth, continuous motions or manipulations in-air, as the user may be subject to inadvertent hand tremors, over compensation by muscles supporting the hand, etc. For input devices, precision in-air usage can be further exacerbated when a user manipulates certain types of input elements that are typically found on conventional peripheral devices, such as spring-loaded depressible buttons, or simultaneously accesses multiple input elements (e.g., two or more buttons using multiple fingers).

In order to instantiate a button press on a conventional spring-type depressible button (e.g., spring, dome, scissor, butterfly, lever, or other biasing mechanism), a user has to impart enough force on the button to cause the button to overcome a resistance provided (e.g., resistance profile) by the biasing mechanism of the depressible button and cause the button to be depressed and make a connection with an electrical contact. The non-uniform downward force and corresponding downward movement of the button, albeit it relatively small, can be enough to adversely affect a user's ability to control input device 300 during in-air use. For instance, the corresponding non-uniform forces applied to one or more button presses may cause a user to slightly move input device 300 when the user is trying to keep it steady, or cause the user to slightly change a trajectory of input device 300. Furthermore, the abrupt starting and stopping of the button travel (e.g., when initially overcoming the biasing mechanisms resistance, and when hitting the electrical contact) can further adversely affect a user's level of control. Thus, a non-depressible input element (e.g., analog button 320) will not be subject to a non-uniform resistance profile of a biasing mechanism, nor the abrupt movements associated with the conventional spring-type buttons described above. Therefore, a user can simply touch analog button 320 to instantiate a button press (e.g., which may be subject to a threshold value) and modulate an amount of force applied to the analog button 320, as described above, which can substantially reduce or eliminate the deleterious forces that adversely affect the user's control and manipulation of input device 300 in in-air operations. It should be noted that other input elements of input device 300 may be non-depressible. In some cases, certain input elements may be depressible, but may have a shorter depressible range and/or may use lower activation thresholds to instantiate a button press, which can improve user control of input device 300 with in-air operations, but likely to a lesser extent than input elements with non-depressible operation.

The activation of multiple input elements may be ergonomically inefficient and could adversely affect a user's control of input device 300, particularly for in-air use. For example, it could be physically cumbersome to press two buttons at the same time, while trying to maintain a high level of control during in-air use. In some embodiments, analog button 320 and grip buttons 340 are configured on housing 305 in such a manner that simultaneous operation can be intuitive and ergonomically efficient, as further described below.

Grip buttons 340 may be configured on a surface of housing 305 and typically on the sides, as shown in FIGS. 3-4. Grip buttons 340 may be configured to allow for a modulated input that can present a range of values corresponding to an amount of force that is applied to them. Grip buttons 340 are configured on input device 300 such that users can hold housing 305 at the location of grip buttons 340 and intuitively impart a squeezing (or pinching) force on grip buttons 340 to perform one or more functions. There are several ergonomic advantages of such a configuration of buttons. For instance, the embodiments described herein, including input device 300, are typically held and manipulated like a pen or paint brush. That is, during operation, a user typically pinches input device 300 between their thumb and one or both of their middle finger and ring finger, and thus manipulation of input device 300 can be intuitive to a user. Grip buttons 340 may be configured in a location such that the user holds grip buttons 340 during normal use and applies a threshold force (e.g., greater than a force applied during normal use and movement of input device 300) to instantiate a button press. Thus, a user may not need to move their grip of input device 300 to instantiate a button press on grip buttons 340, as their finger may already be configured over them. Performing a squeezing action on grip buttons 340 to instantiate a button press can be an intuitive action for a user, particular when an associated function includes “grabbing” or picking up a virtual object in an AR/VR environment, which may be similar to how a user would pick up an object in the real world. Grip buttons 340 are typically configured on opposite sides of housing 305 such that a squeezing force provided on both sides (e.g., typically by the thumb and middle/ring finger) tend to cancel each other out, which can reduce unwanted deleterious forces that may affect a user's accuracy and precision of control. Grip buttons 340 may be depressible or non-depressible, as described above, and each may include a load cell to generate an analog output corresponding to a user's squeezing force.

As indicated above, any myriad functions can be associated with grip buttons 340. For instance, grip buttons 340 may be used to grab and/or pick up virtual objects. When used in tandem with another controller (e.g., used contemporaneously in a different hand), a function can include moving and/or scaling selected object. Grip buttons 340 may operate to modify the functions of other input elements of input device 300, such as tip 310, analog button 320, touch pad 330, menu button 350, or system button 360, in a manner comparable to (but not limited by) how a shift/alt/control key modifies a key on a keyboard. Other possible non-limiting functions include accessing modification controls of a virtual object (e.g., entering an editing mode), or extending a 2D split line along a third axis to create a 3D surface. One of ordinary skill in the art with the benefit of this disclosure would appreciate the many modifications, variations, and alternative functions thereof.

In some embodiments, input device 300 may have one grip button 340 configured on housing 305. A single grip button 340 can still detect a squeezing force, but on a single button rather than two buttons. As indicated above, grip buttons are typically located opposite to one another on housing 305, as shown in FIGS. 3 and 4, although other locations are possible. Housing 305 can be described as having two zones: a first zone (towards the front of input device 300) where the various input elements are located, which may correspond to the visible zone shown in FIG. 4; and a second zone (towards the back of input device 300), which may include features (e.g., motion tracking sensors, etc.) used for tracking a usage and movement of input device 300 in 3D space (e.g., in three or six degrees of freedom). The first zone may include a first region located at or near the front of input device 300 where analog tip 310 is located, and a second region where grip buttons 340 are located. The second region may include areas on opposite sides of housing 305 that may be described as first and second sub-regions, which may correspond to the areas where grip buttons 340 are configured, respectively. In some cases, the first and second sub-regions are configured laterally on opposite sides of the housing (e.g., as shown in FIG. 4) and each grip button 340 can include a sensor set (e.g., one or more load cells) to detect the squeezing force, as described above.

In some embodiments, touch pad 330 may be configured on a surface of housing 305, as shown in FIGS. 3-4. Touch pad 330 may be touch sensitive along its surface and may be a resistive-based sensor, capacitance-based sensor, or the like, as further described above. Touch pad 330 may further be force sensitive to detect a pressing force along all or at least a portion of touch pad 330. For example, touch pad 330 may include a sensor set (e.g., one or more load cells) disposed underneath to detect the pressing force. In some embodiments, touch pad 330 may incorporate touch sensing compensation to compensate for potential non-uniform force detection along the surface of touch pad 330. For example, a touch pad may include a load cell configured beneath a portion of the full length of the touch pad and pressing forces applied to areas directly above or adjacent to the load cell may be detected as a higher pressing force than an identical pressing force applied to an area on the surface of the touch pad that is farther away from the load cell. This if further discussed with respect to FIG. 10 below. In some alternative embodiments, similar functionality provided by the non-moveable elements (e.g., analog button 320, grip button(s) 340, etc.) of FIG. 3 may be achieved through mechanical designs with a mechanical primary button a grip button, which include elements that can be pinched, squeezed, moved relative to each other in order to produce similar pressure value readings using similar sensors or, for instance, to measure the positional change or deflection of an input element (e.g., slider, joystick, etc.) relative to one another. Such mechanical implementations are not preferred however, given the ergonomic and performance reasons described above.

Any number of functions may be associated and controlled by touch pad 330, according to certain embodiments. Some of these functions are depicted in the tables of FIGS. 4 and 5A-5B. For instance, touch pad 330 may be configured to allow a user to adjust one or more controls (e.g., virtual sliders, knobs, etc.) using swipe gestures. In some cases, touch pad 330 can be used to change properties of a spline curve that extends from a 2D surface to a 3D in-air location (e.g., created using analog tip 310 on a 2D surface and analog button 320 to seamlessly transition to 3D space). In such cases, touch pad 330 can be used to reskin the spline (scrolling through reskin options), softening or hardening a resolution of the continuous stroke, incorporating more nodes (with upstrokes) or fewer nodes on the spline (with downstrokes), selecting spline modifiers (for freehand drawn splines) including normalizing the spline, changing the spline count, optimizing the spline, and changing the thickness and drape for overlapping conditions, or the like. In some cases, touch pad 330 can be split into multiple touch sensitive areas, such that a different function may be associated with different touch sensitive area. For example, a first area may be associated with an undo function, and a second area may be associated with a redo function. In some cases, touch pad 330 may be configured to adjust properties of a rendered object in virtual space (e.g., displayed by an HMD), such as adjusting a number of nodes in split-line curve, or adjusting a size of the rendered object (e.g., scale, extrusion length, etc.). In some aspects, touch pad 330 may be used as a modifier of 2D or 3D object in an AR/VR/MR environment. Touch pad 330 can be used to change the properties of a selected line/spline/3D shape, etc., by scrolling along the touch pad, which may modify certain dimensions (e.g., the height of a virtual cylinder), modify a number of nodes on a spline (curve), or the like. In some cases, a user may point at a rendered menu in an AR/VR environment using input device 300 and interface with touch pad 330 to adjust and control sliders, knobs, buttons, or other items in a menu, scroll through a menu, or other functions (e.g., gesture controls, teleport in AR/VR environment, etc.). One of ordinary skill in the art with the benefit of this disclosure would appreciate the many possible functions and corresponding variations thereof. Although touch pad 330 is shown in a particular configuration, other shapes, sizes, or even multiple touch sensitive areas are possible.

Menu button 350 can be a switch configured to allow virtual menus (e.g., in AR/VR space) to be opened and closed. Some examples may include a contextual menu related to a function of input device 300 in virtual space (e.g., changing a virtual object's color, texture, size, or other parameter; copy and/or paste virtual objects, etc.) and holding menu button 350 (e.g., over 1 second) to access and control complex 3 DOF or 6 DOF gestures, such as rotation swipes, multiple inputs over a period of time (e.g., double taps, tap-to-swipe, etc.). Some embodiments may not include menu button 350, as other input elements may be configured to perform similar functions (e.g., touch pad 330).

System button 360 may be configured to establish access to system level attributes. Some embodiments may not include menu button 350, as other input elements may be configured to perform similar functions (e.g., touch pad 330). In some aspects, system button 360 may cause the operating system platform (e.g., a VR platform, Windows/Mac default desktop, etc.) to return to the “shell” or “home” setting. A common usage pattern may be to use the system button to quickly return to the home environment from a particular application, do something in the home environment (e.g., check email), and then return to the application by way of a button press.

The various input elements of input device 300 described above, their corresponding functions and parameters, and their interaction with one another (e.g., simultaneous operation) present a powerful suite of intuitive controls that allow users to hybridize 2D and 3D in myriad new ways. By way of example, there are many forms of editing that could be activated on shapes and extrusions the user has created. For instance, a user may start by drawing a curve or shape on a surface (digital or physical) using tip 310, analog button 320, or a combination thereof; then the user may drag that shape along a path into 3D space using grip button 840 as described above; and finally the user may use touch pad 330 to edit the properties of the resulting surface or extrusion. For example, a user could use touch pad 330 to scroll through nodes on that particular shape/curve/surface, color, texture, or the like. Input device 300 can be configured to work across various MR/VR/AR modes of operation, such that a corresponding application programming interface (API) could recognize that a rendered object, landscape, features, etc., is in an occluded state (VR), a semi-occluded state (AR) or fully 3D (MR), or flat when viewed on a display screen (e.g., tablet computer).

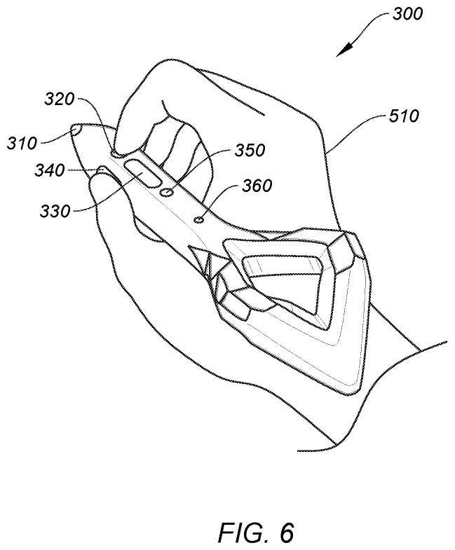

The input devices described herein can offer excellent control, dexterity, and precision for a variety of applications. FIG. 6 shows a user holding and operating an input device in a typical manner, according to certain embodiments. Referring to FIG. 6, a user 510 is holding input device 300 with a pinch grip-style and simultaneously accessing both analog button 320 and grip buttons 330. Analog button 320 and grip buttons 330 may or may not be activated, which may depend on a corresponding force threshold for each input element, as further described above. A user's hand 510 is shown holding a bottom portion (a first region) of input device 300 between their thumb and fingers (e.g., index finger and middle finger), with a second region (e.g., the region where housing 305 splits and includes planar facets) resting on a portion of the user's hand between the thumb and index finger (the “purlicue”). A user may use only the index finger, or three or more fingers in a preferred grip style. The user may grip higher up or lower on the first region as desired. The first region may include areas of housing 305 that have input elements, as described above.

FIG. 7 shows an input device 300 performing a function on a 2D surface 700, according to certain embodiments. A user's hand 710 is shown holding tip 310 of input device 300 against surface 700 and maintaining contact while moving in a continuous fashion from point A to point C. As described above, tip 310 can be configured to detect a pressing force by a sensor set (e.g., a load cell) coupled to tip 310. In some embodiments, any contact of tip 310 on a surface may cause input device 300 to generate a control signal corresponding to a function, such as a drawing function. Alternatively or additionally, a pressing force at or above a particular threshold force may instantiate the function. Referring to FIG. 7, a user applies tip 310 to surface 700 at point A and being moving to point B. During this period, a drawing function (e.g., a rendered line in an AR/VR environment) is applied. The function may have one or more parameters, including line width (also referred to as point size), color, resolution, type, or the like. At point B, the user applies a greater pressing force and the line width is increased. At point C, the user maintains the pressing force and the line width remains the same. Although a single parameter (line width) and two line widths are shown, one of ordinary skill in the art with the benefit of this disclosure would understand that multiple functions and corresponding parameters can be associated with tip 310 (or any other input element) and any number of different force thresholds can be applied to modulate the associated functions and parameters.

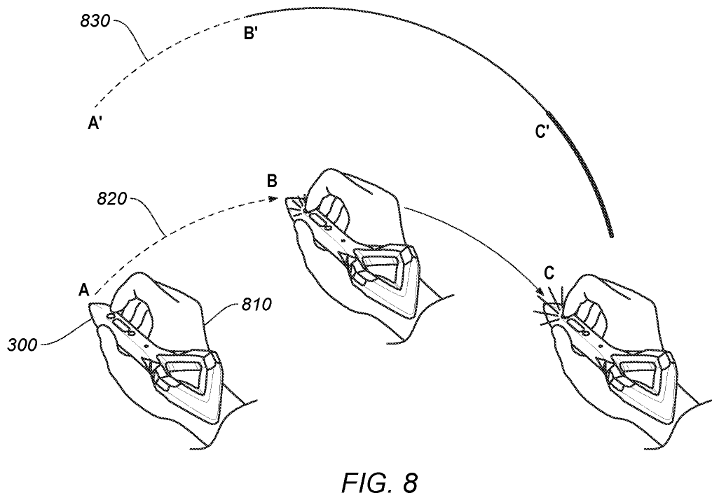

FIG. 8 shows an input device 300 performing a function in 3D space, according to certain embodiments. A user 810 is shown to be moving input device 300 along a continuous arc (movement arc 820) in mid-air from points A to C. A resulting corresponding function output is shown in drawing arc 830. At point A, user 810 begins moving along arc 820. The user is operating mid-air, thus tip 310 is not contacting a surface (e.g., no pressing force is detected) and tip 310 is not causing input device 300 to generate a drawing/painting function, as shown in FIG. 7. Furthermore, user 810 is not contacting analog input 320 (e.g., not providing a pressing force). As such, no drawing function (or other associated function) is applied until input device reaches point B. At point B, the user continues along movement arc 820 but begins applying a pressing force to analog input (button) 320. The pressing force can be set to any suitable threshold (e.g., 1 g, 5 g, 10 g, 20 g, 30 g, etc.) to trigger the corresponding function (e.g., rendering a line in an AR/VR environment), which can range from any non-zero detected pressing force (e.g., 10 g). In response, input device 300 begins rendering a line function corresponding to a location, orientation, and movement of tip 310 in 3D space starting at B′ in drawing arc 830. The rendered line may maintain a uniform thickness (e.g., a parameter of the line function) until input device 300 reaches point C of movement arc 820. At point C, the user continues along movement arc 820 but begins applying more pressing force to analog input 320, where the more pressing force is greater than a second pressing force threshold associated with analog input 320 (e.g., the first pressing force may trigger the first function once the pressing force meets or exceeds the threshold (activation) force, such as 10 g, but remains below a second pressing force threshold (e.g., 30 g). The second pressing force threshold (activation force) may be higher (e.g., 30 g). In response to receiving a pressing force more than a second pressing force threshold (e.g., 30+ g), input device 300 continues rendering the line in a continuous fashion, but increases the line width, as shown at C′ of drawing arc 830. The example of FIG. 8 is not intended to be limiting and one of ordinary skill in the art with the benefit of this disclosure would appreciate the many modifications, variations, and alternative embodiments thereof. For instance, providing a range of squeezing forces on grip buttons 840 may cause a similar result. Alternatively or additionally, triggering grip buttons 840 while performing the function shown in FIG. 8 may cause a second function to occur. For example, modulating a squeezing force while drawing a line along drawing arc 830 in the manner described above may cause the color or patterning of the line to change. Other combinations and/or configurations are possible and the embodiments described herein are intended to elucidate the inventive concepts in a non-limiting manner.

FIG. 9 shows an input device 300 manipulating a rendered object in an AR/VR environment 900, according to certain embodiments. User 910 is performing a grab function at location A in the AR/VR environment by pointing input device 300 toward object 920 and providing a squeezing force to grip buttons 340, as described above. In some embodiments, the object may be selected by moving a voxelated (3D) cursor (controlled by input device 300) over object 920 and performing the grab function, or other suitable interfacing scheme. User 910 then moves input device 300 to location B while maintaining the grab function, thereby causing object 920 to move to location B′ in the AR/VR environment.

FIG. 10 shows aspects of input detection and compensation on an input device 1000, according to certain embodiments. Input device 1000 may be similar to input device 300 of FIG. 3. Input device 1000 includes housing 1005 with input elements disposed thereon that can include tip 1010, analog button 1020, touch pad 1030, grip button(s) 1040, menu button 1050, and system button 1060. In some embodiments, touch pad 1030 may incorporate touch sensing compensation to compensate for potential non-uniform force detection along the surface of touch pad 330. For example, a touch pad may include a load cell 1035 configured beneath a portion of the full length of touch pad 1030 and pressing forces applied to areas directly above or adjacent to the load cell may be detected as a higher pressing force than an identical pressing force applied to an area on the surface of the touch pad that is farther away from the load cell. For example, finger 1010 may slide along touch sensor 1030 and provides a pressing force at one end. The farther the pressing force is applied from load cell 1025, the more attenuated the detected pressing force may likely be.

In order to compensate for attenuations, input device 1000 can use a detected location of the user's finger 1010 on touch pad 1030 using touch sensing capabilities, as described above. By knowing where a user's finger is relative to a location of load cell 1020, a compensation algorithm can be applied to modify a detected pressing force accordingly. For instance, referring to FIG. 10, user 1010 touches the touch pad 1030 at positions 1 (left side), 2 (center), and 3 (right side). For the reasons described above, the force applied at positions 1-3 may not register as the same, despite that user 1010 is, in fact, applying the same pressure at each point. Knowing the touch position at positions 1-3, along with the raw load cell measurements, can allow the system to “normalize” the force output. In the example above, a normalization would result in a same resultant force value being read at positions 1-3 when the user is actually applying a same force at each location. For example, user 1010 may apply 200 g of force on touch sensor 1030 at position 2, and the corresponding load cell (1035) may report 50% of the maximum scale. User 1010 at position 1 may apply the same 200 g of force, but the load cell may report only 30% of its maximum scale as the force is not applied directly over the load cell (e.g., due to lever mechanism forces). Since the system knows that the touch position is at position 1, then the system can re-scale the value of the load cell measurements based on the touchpad position to be 50%. Thus, the same resultant value can be measured for a 200 g applied force, regardless of the position of the user 1010 on the surface of the touch pad 1030.

FIG. 11 shows a flow chart for a method 1100 of operating an input device 300, according to certain embodiments. Method 1100 can be performed by processing logic that may comprise hardware (circuitry, dedicated logic, etc.), software operating on appropriate hardware (such as a general purpose computing system or a dedicated machine), firmware (embedded software), or any combination thereof. In certain embodiments, method 1100 can be performed by aspects of system 200, such as processors 210, input detection block 220, or any suitable combination thereof, as would be appreciated by one of ordinary skill in the art with the benefit of this disclosure.

At operation 1110, method 1100 can include receiving first data corresponding to a tip of the stylus device (tip 310, also referred to as the “nib”) being pressed against a physical surface. The first data may be generated by a first sensor set (e.g., one or more load cells) configured at the tip of the stylus device (e.g., coupled to tip 310) and controlled by one or more processors disposed within the stylus device, according to certain embodiments.

At operation 1120, method 1100 can include generating a function in response to receiving the first data, according to certain embodiments. Any suitable function may be generated, including a writing function, painting function, AR/VR element selection/manipulation function, etc., as would be appreciated by one of ordinary skill in the art with the benefit of this disclosure.

At operation 1130, method 1100 can include receiving second data corresponding to an input element on the stylus device being pressed by a user, the second data generated by a second sensor set (e.g., load cell(s)) configured on the side of the stylus device and controlled by the one or more processors, according to certain embodiments. For example, the input element may be analog input (analog button) 320. Alternatively or additionally, the input element may correspond to touch pad 330 (may also be a “touch strip”), menu button 350, system button 360, or any suitable input element with any form factor, as would be appreciated by one of ordinary skill in the art with the benefit of this disclosure.

At operation 1140, method 1100 can include generating the function in response to receiving the second data, according to certain embodiments. Any function may be associated with the input element, including any of the functions discussed above with respect to FIGS. 1A-10 (e.g., instantiating a writing function in-air, selecting an element in AR/VR space, etc. The first data may include a first detected pressing force corresponding to a magnitude of force detected by the first sensor set, and wherein the second data includes a second detected pressing force corresponding to a magnitude of force detected by the second sensor set.

At operation 1150, method 1100 can include modulating a parameter of the function based on either of the first detected pressing force or the second detected pressing force, according to certain embodiments. For example, a writing function may include parameters such as a line size (point size), a line color, a line resolution, a line type (style), or the like. As described above, any function (or multiple functions) may be associated with any of the input elements of input device 300, and any adjustable parameter may be associated with said function(s), as would be appreciated by one of ordinary skill in the art with the benefit of this disclosure.

At operation 1160, method 1100 can include receiving third data corresponding to the stylus device being squeezed, the third data generated by a third sensor set (e.g., one or more load cell(s)) coupled to the stylus device and controlled by the one or more processors, according to certain embodiments. For example, the third sensor set may correspond to grip button(s) 340.

In some aspects, one grip button or two grip buttons (with corresponding sensors) may be employed, as discussed above.

At operation 1170, method 1100 can include generating a second function in response to receiving the third data, according to certain embodiments. In some cases, the second function may typically include a grab function, or other suitable function such as a modifier for other input elements (e.g., tip 310, analog button 320, touch pad 330, etc.), as described above.

In some cases, the third data may include a detected magnitude of a squeezing force. Thus, at operation 1180, method 1100 can include modulating a parameter of the second function based on a detected magnitude of the squeezing force, according to certain embodiments. In some configurations, the magnitude of the squeezing force (e.g., an activation force) to instantiate a function (e.g., a grab function on an object in an AR/VR environment) may be approximately 1-1.5 kg. In some cases, there may not be an “activation force;” that is, some implementations may apply a grab function in response to any detected squeezing force, or modulate aspects of the grab function (e.g., a greater squeezing force may be required to manipulate object with more virtual mass). In some cases, the activation force may be lower than 1 kg or greater than 1.5 kg, and may be set by default, by a user through software or firmware, or by machine learning based on how the user interacts with input device 300 over time. One of ordinary skill in the art with the benefit of this disclosure would appreciate the many modifications, variations, and alternative embodiments thereof.

It should be appreciated that the specific steps illustrated in FIG. 11 provide a particular method 1100 for operating an input device (300), according to certain embodiments. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

As used in this specification, any formulation used of the style “at least one of A, B or C”, and the formulation “at least one of A, B and C” use a disjunctive “or” and a disjunctive “and” such that those formulations comprise any and all joint and several permutations of A, B, C, that is, A alone, B alone, C alone, A and B in any order, A and C in any order, B and C in any order and A, B, C in any order. There may be more or less than three features used in such formulations.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Unless otherwise explicitly stated as incompatible, or the physics or otherwise of the embodiments, example or claims prevent such a combination, the features of the foregoing embodiments and examples, and of the following claims may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of the example(s), embodiment(s), or dependency of the claim(s). Moreover, this also applies to the phrase “in one embodiment”, “according to an embodiment” and the like, which are merely a stylistic form of wording and are not to be construed as limiting the following features to a separate embodiment to all other instances of the same or similar wording. This is to say, a reference to ‘an’, ‘one’ or ‘some’ embodiment(s) may be a reference to any one or more, and/or all embodiments, or combination(s) thereof, disclosed. Also, similarly, the reference to “the” embodiment may not be limited to the immediately preceding embodiment.

Certain figures in this specification are flow charts illustrating methods and systems. It will be understood that each block of these flow charts, and combinations of blocks in these flow charts, may be implemented by computer program instructions. These computer program instructions may be loaded onto a computer or other programmable apparatus to produce a machine, such that the instructions which execute on the computer or other programmable apparatus create structures for implementing the functions specified in the flow chart block or blocks. These computer program instructions may also be stored in a computer-readable memory that can direct a computer or other programmable apparatus to function in a particular manner, such that the instructions stored in the computer-readable memory produce an article of manufacture including instruction structures which implement the function specified in the flow chart block or blocks. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flow chart block or blocks. Accordingly, blocks of the flow charts support combinations of structures for performing the specified functions and combinations of steps for performing the specified functions. It will also be understood that each block of the flow charts, and combinations of blocks in the flow charts, can be implemented by special purpose hardware-based computer systems which perform the specified functions or steps, or combinations of special purpose hardware and computer instructions.

For example, any number of computer programming languages, such as C, C++, C# (CSharp), Perl, Ada, Python, Pascal, SmallTalk, FORTRAN, assembly language, and the like, may be used to implement machine instructions. Further, various programming approaches such as procedural, object-oriented or artificial intelligence techniques may be employed, depending on the requirements of each particular implementation. Compiler programs and/or virtual machine programs executed by computer systems generally translate higher level programming languages to generate sets of machine instructions that may be executed by one or more processors to perform a programmed function or set of function

The foregoing description of one or more implementations provides illustration and description, but is not intended to be exhaustive or to limit the scope of the invention to the precise form disclosed. Modifications and variations are possible in light of the above teachings or may be acquired from practice of various implementations of the present disclosure.

What is claimed is:

1. A stylus device comprising:
a housing;
a first sensor set configured on a surface of the housing; and
a second sensor set configured on the surface of the housing, the first and second sensor sets controlled by and in electronic communication with one or more processors,
wherein the one or more processors are configured to generate a first function in response to the first sensor set detecting a pressing force on a first region of the housing, and
wherein the one or more processors are configured to generate a second function in response to the second sensor set detecting a squeezing force on a second region of the housing.

2. The stylus of claim 1 wherein a first parameter of the first function is modulated based on a magnitude of the first pressing force on the first region, and
wherein a parameter of the second function is modulated based on a magnitude of the squeezing force on the second region.

3. The stylus of claim 1 further comprising:
a third sensor set configured at an end of the housing, the third sensor set controlled by and in electronic communication with the one or more processors,
wherein the one or more processors are configured to generate the first function in response to the third sensor set detecting a third pressing force that is caused when the end of the housing is pressed against a physical surface.

4. The stylus of claim 3 wherein the first sensor set includes a first load cell coupled to a user accessible button configured in the first region on the surface of the housing,
wherein the second region includes a first sub-region and a second sub-region, the first and second sub-regions configured laterally on opposite sides of the housing,
wherein the second sensor set includes at least one load cell on at least one of the first or second sub-regions, and
wherein the third sensor set includes a load cell coupled to a nib on the end of the housing.

5. The stylus of claim 1 wherein the housing is configured to be held by a user's hand such that the first sensor set is accessible by the user's index finger, the second sensor set is accessible by the user's thumb and at least one of the user's index or middle finger, and a rear portion of the housing is supported by the user's purlicue region of the user's hand.

6. A method of operating a stylus device, the method comprising:
receiving first data corresponding to a tip of the stylus device being pressed against a physical surface, the first data generated by a first sensor set configured at the tip of the stylus device and controlled by one or more processors disposed within the stylus device;
generating a function in response to receiving the first data;
receiving second data corresponding to an input element on the stylus device being pressed by a user, the second data generated by a second sensor set configured on the side of the stylus device and controlled by the one or more processors; and
generating the function in response to receiving the second data.

7. The method of claim 6 wherein the first data includes a first detected pressing force corresponding to a magnitude of force detected by the first sensor set, and wherein the second data includes a second detected pressing force corresponding to a magnitude of force detected by the second sensor set.

8. The method of claim 7 further comprising modulating a parameter of the function based on either of the first detected pressing force or the second detected pressing force.

9. The method of claim 6 further comprising:
receiving third data corresponding to the stylus device being squeezed, the third data generated by a third sensor set coupled to the stylus device and controlled by the one or more processors; and
generating a second function in response to receiving the third data.

10. The method of claim 9 wherein the third data includes a detected magnitude of a squeezing force, and wherein the method further comprises modulating a parameter of the second function based on a detected magnitude of the squeezing force.

11. A stylus device comprising:
a housing configured to be held by a user while in use, the housing including:
a first sensor set configured at an end of the housing; and
a second sensor set configured on a surface of the housing, the first and second sensor sets controlled by and in electronic communication with one or more processors,
wherein the one or more processors are configured to generate a function in response to the first sensor set detecting a first pressing force that is caused when the end of the housing is pressed against a physical surface,
wherein the one or more processors are configured to generate the function in response to the second sensor set detecting a second pressing force that is caused when the user presses the second sensor, and
wherein a parameter of the function is modulated based on a magnitude of either the first pressing force or the second pressing force.

12. The stylus device of claim 11 wherein the first sensor set includes a load cell coupled to a nib on the end of the housing.

13. The stylus device of claim 11 wherein the second sensor set includes a load cell coupled to a button on the surface of the housing.

14. The stylus device of claim 11 further comprising a touch-sensitive touchpad configured on the surface of the housing, the touchpad controlled by and in electronic communication with the one or more processors, wherein the touchpad is configured to detect a third pressing force on a surface of the touchpad.

15. The stylus device of claim 14 wherein touchpad includes one or more load cells coupled thereto, wherein the one or more processors are configured to determine a resultant force signal based on a magnitude of the third pressing force and a location of the third pressing force relative to the one or more load cells.

16. The stylus device of claim 11 further comprising a third sensor set coupled to one or more sides of the housing and configured to be gripped by a user while the stylus device is in use,
wherein the third sensor set is controlled by and in electronic communication with the one or more processors, and
wherein the one or more processors are configured to generate a second function in response to the third sensor set detecting a gripping force that is caused when the user grips the third sensor set.

17. The stylus device of claim 11 wherein the stylus device is configured for operation in an augmented reality (AR) or virtual reality (VR) environment.

18. The stylus device of claim 17 wherein the second function is a digital object grab function performed within the AR or VR environment.

19. The stylus device of claim 11 further comprising a communications module disposed in the housing and controlled by the one or more processors, the communications module configured to establish a wireless electronic communication channel between the stylus device and at least one host computing device.

20. The stylus device of claim 11 wherein the function corresponds to a digital line configured to be rendered on a display, and wherein the parameter is one of:
a line size;
a line color;
a line resolution; or
a line type.
